(19) United States
(12) Patent Application Publication
(10) Pub. No.: US 2022/0024161 A1
(43) Pub. Date: Jan. 27, 2022

(54) METHOD OF INTRODUCING A ROTOR BLADE SPAR CAP INTO A ROTOR BLADE SHELL, A SPAR CAP MOLD, A ROTOR BLADE, AND A WIND ENERGY INSTALLATION

(71) Applicant: Siemens Gamesa Renewable Energy Service GmbH, Hamburg (DE)

(72) Inventor: Enno Eyb, Kiel (DE)

(21) Appl. No.: 17/298,431

(22) PCT Filed: Nov. 25, 2019
(86) PCT No.: PCT/EP2019/082400

§ 371 Date: May 28, 2021

(51) Int. Cl. B29C 70/84; B29C 70/68

(52) U.S. Cl. CPC B29C 70/84; B29L 2031/085; B29C 70/682

(57) ABSTRACT

A method of introducing a rotor blade spar cap into a rotor blade shell for a rotor blade of a wind energy installation, a spar cap mold for manufacturing a rotor blade spar cap, a rotor blade comprising such a spar cap, and a wind energy installation including such a rotor blade. At least two strip-shaped spar cap elements are arranged on at least one substantially flat spar cap forming surface of the spar cap mold. The at least one spar cap forming surface extends along a longitudinal direction of the spar cap mold which corresponds to a longitudinal axis of the rotor blade. The spar cap elements are arranged on the at least one spar cap forming surface along the longitudinal direction and are connected to one another so as to form the rotor blade spar cap. The spar cap elements connected to one another are removed from the spar cap mold, are introduced into the rotor blade shell, and are connected to the rotor blade shell.

### CROSS-REFERENCE TO RELATED APPLICATIONS

This application is a national phase application under 35 U.S.C. § 371 of International Patent Application No. PCT/EP2019/082400, filed Nov. 25, 2019 (pending), which claims the benefit of priority to German Patent Application No. DE 10 2018 009 339.6, filed Nov. 28, 2018, the disclosures of which are incorporated by reference herein in their entirety.

### TECHNICAL FIELD

The present invention relates to a method of introducing a rotor blade spar cap into a rotor blade shell for a rotor blade of a wind energy installation, to a spar cap mold for manufacturing a rotor blade spar cap for a rotor blade of a wind energy installation, to a rotor blade comprising such a spar cap, as well as to a wind energy installation comprising such a rotor blade.

### BACKGROUND

Rotor blades for wind energy installations are often assembled from two rotor blade shells which are manufactured separately. One or more spar caps can be provided in the interior of the rotor blade, which spar caps run substantially along a longitudinal axis of the rotor blade from the rotor blade root to the rotor blade tip and which provide additional robustness, or which have an impact on elastic properties of the rotor blade.

In general, in the manufacture of such rotor blades, prefabricated, strip-shaped spar cap parts are placed loosely in a rotor blade shell provided, are pressed against the rotor blade shell, if necessary through the application of a vacuum, and are fixed to the rotor blade shell, for example by means of a resin infusion process. Due to the curvature of the rotor blade shell, the pressing of the spar cap parts against the blade shell may cause the spar cap parts to break. However, even if no breakage occurs, the assembled spar cap and thus potentially the entire rotor blade is under tension.

### SUMMARY

It is an object of the present invention to provide a method for the improved introduction of a rotor blade spar cap into a rotor blade shell, to provide a spar cap mold for manufacturing a rotor blade spar cap, and to provide a rotor blade, as well as a corresponding wind energy installation. In particular, it is an object of the invention to increase the robustness of a composite of a rotor blade shell and a rotor blade spar cap and/or to reduce any stresses in the rotor blade spar cap.

This object is solved by a method of introducing a rotor blade spar cap into a rotor blade shell, by a rotor blade, as well as by a wind energy installation in accordance with the present disclosure.

In accordance with a first aspect of the invention, in a method of introducing a rotor blade spar cap into a rotor blade shell for a rotor blade of a wind energy installation, which rotor blade has a rotor blade longitudinal axis which extends from a rotor blade root to a rotor blade tip, at least two strip-shaped spar cap elements are arranged, in particular one above the other and/or next to each other, on at least one substantially flat spar cap forming surface of a spar cap mold. In this context, the at least one spar cap forming surface extends along a longitudinal direction of the spar cap mold which corresponds to the longitudinal axis of the rotor blade. The spar cap elements which are arranged on the at least one spar cap forming surface along the longitudinal direction are connected to one another so as to form the rotor blade spar cap. The spar cap elements connected to one another are removed from the spar cap mold, are introduced into the rotor blade shell, and are connected to the rotor blade shell.

In accordance with a second aspect of the invention, a spar cap mold for manufacturing a rotor blade spar cap for a rotor blade of a wind energy installation has at least two substantially flat spar cap forming surfaces for receiving at least two strip-shaped spar cap elements. The at least two spar cap forming surfaces extend along a longitudinal direction of the spar cap mold, which longitudinal direction of the spar cap mold corresponds to a rotor blade longitudinal axis of the rotor blade extending from a rotor blade root to a rotor blade tip, the at least two spar cap forming surfaces are located next to each other in a transverse direction of the spar cap mold, which transverse direction extends perpendicular to the longitudinal direction, and they are inclined with respect to each other in the transverse direction.

In accordance with a third aspect of the invention, a rotor blade for a wind energy installation comprises at least one rotor blade shell into which is introduced a rotor blade spar cap which has been manufactured by the method in accordance with the first aspect of the invention and/or using a spar cap mold in accordance with the second aspect of the invention.

In accordance with a fourth aspect of the invention, a wind energy installation comprises at least one rotor blade in accordance with the third aspect of the invention.

Preferred aspects of the invention are based on the approach of arranging strip-shaped spar cap elements of the rotor blade spar cap which have been prefabricated, for example by means of a pultrusion process, not only in the rotor blade shell, but arranging them in a spar cap mold already before insertion into the rotor blade shell and connecting them there so as to form the rotor blade spar cap. The spar cap mold used for this purpose has one or more flat spar cap forming surfaces on which the strip-shaped spar cap elements can be placed, in particular in accordance with their desired arrangement in the rotor blade shell, for example along a longitudinal direction which corresponds to a rotor blade longitudinal axis. Due to the increased bending stiffness of the connected spar cap elements when compared with the bending stiffness of individual spar cap elements, it is possible to avoid, or at least to reduce, stresses when the spar cap is being connected to the rotor blade shell. In addition, the resistance of the spar cap elements, connected to one another, to deformation generated, for example, by the application of a vacuum can also be increased by means of this.

In this context, it is possible, for example, to arrange two or more strip-shaped spar cap elements, which may possibly be of different lengths, one above the other on a single spar cap forming surface, i. e. to stack them, and to join them together, for example by means of a resin infusion process, and then to remove them from the spar cap mold and to insert them into the rotor blade shell. This is advantageous, for example, if the spar cap elements already have a width that corresponds to a desired width of the rotor blade spar cap.

In addition or as an alternative, it is also possible to arrange two or more strip-shaped spar cap elements, in particular of the same length, next to each other on two or more spar cap forming surfaces located next to each other. This is advantageous, for example, if the desired width of the rotor blade spar cap is greater than the width of the individual spar cap elements.

In this context, the rotor blade spar cap can be composed of spar cap elements which are of the same type, or however also of spar cap elements which are of a different type. Preferably, the spar cap elements are fiber composites which have been manufactured by means of a pultrusion process (pultruded products, as they are referred to), such as carbon composites. Spar cap elements can, however, be formed by stiffening elements, which are preferably obtained in a sandwich construction and which have, for example, a core layer of foam material or of balsa wood surrounded by cover layers. Such stiffening elements can be arranged in the spar cap mold, for example, on, under or between the pultruded fiber composites, and can be connected to these so as to form the rotor blade spar cap. In particular, it is advantageous to arrange such a stiffening element in a region of the spar cap mold which corresponds to a rotor blade tip on only one pultruded fiber composite in order to increase the bending stiffness of the rotor blade spar cap at the blade tip of the rotor blade.

The method in accordance with the invention also has the advantage that spar cap elements which are easy to manufacture from a technical point of view and/or which are particularly economical can be used to assemble the rotor spar cap in the spar cap mold. For example, it is conceivable to use spar cap elements with cross sections that, due to their deformability, would be unsuitable or at least disadvantageous for separate insertion into the rotor blade shell. In addition to a reduction of the overall weight, this also enables a high precision in the manufacture of the spar cap elements and thus of the rotor blade spar cap to be achieved. In addition, a rotor blade comprising the rotor blade shell with such a rotor blade spar cap can withstand higher thermal and/or mechanical loads.

Overall, the introduction of rotor blade spar caps into rotor blade shells is improved by means of the invention. In particular, by means of the invention, the robustness of a composite of a rotor blade shell and a rotor blade spar cap can be increased, and in particular stresses in the rotor blade spar cap can be reduced.

In a preferred embodiment, at least two of the strip-shaped spar cap elements are arranged next to each other on at least two substantially flat spar cap forming surfaces which are inclined with respect to one another in a transverse direction which extends perpendicular to the longitudinal direction. In this context, the inclination of the spar cap forming surfaces with respect to one another is preferably matched to a curvature of the rotor blade shell in relation to a rotor blade transverse axis which runs perpendicular to the rotor blade longitudinal axis. In this way, a rotor blade spar cap can be manufactured from strip-shaped spar cap elements, in particular from strip-shaped spar cap elements with a rectangular cross section, which rotor blade spar cap has a curvature which is at least approximated by means of the spar cap forming surfaces which are inclined with respect to one another. A cavity which is formed between the connected spar cap elements and the rotor blade shell when the connected spar cap elements are being inserted into the rotor blade shell can be reduced in this way so that, for example, the robustness of the rotor blade is increased and/or less resin is required in order to fill this cavity and to connect the connected spar cap elements to the rotor blade shell in a reliable manner.

In a further preferred embodiment, the at least two strip-shaped spar cap elements are arranged on a surface of the spar cap mold formed by the at least two spar cap forming surfaces which are inclined with respect to one another, wherein, in the cross section perpendicular to the longitudinal direction, the surface follows a polygonal chain, which polygonal chain replicates or approximates a curvature of the rotor blade shell in relation to a rotor blade transverse axis which is perpendicular to the rotor blade longitudinal axis. Such a polygonal chain corresponding to the curvature of the rotor blade shell can easily be determined, for example by means of mathematical optimization methods, for example from a model of the rotor blade. In this context, in a preferred manner, the connecting edges of the polygonal chain correspond to portions of the rotor blade shell, with each connecting edge running substantially parallel to, but at least tangentially to, the rotor blade shell in the corresponding portion.

The rotor blade spar cap can therefore be optimally adapted to the curvature of the rotor blade shell, in particular in relation to the predetermined width of its spar cap elements, so that no stresses are generated in the rotor blade spar cap when it is being inserted into the rotor blade shell.

In a further preferred embodiment, the at least two strip-shaped spar cap elements are connected to one another in the spar cap mold by a resin infusion process and, after at least a partial curing of the resin, are removed from the spar cap mold and are introduced into the rotor blade shell. By means of this, it can be ensured that the spar cap elements retain the desired arrangement, in particular the desired arrangement corresponding to the curvature of the rotor blade shell, when they are being introduced into the rotor blade shell, i. e. that, for example, inadvertent movement is reliably prevented.

This also has the advantage that the bending stiffness of the rotor blade spar cap introduced into the rotor blade shell is increased when compared with spar cap elements introduced individually. Thus, for example, the risk of unintentionally deforming the rotor blade spar cap during the course of its introduction into the rotor blade shell can also be reduced.

In a further preferred embodiment, a deformable filling material is inserted into the rotor blade shell. The spar cap elements connected to one another are then placed on the deformable filling material. The deformable filling material can in particular be of a compressible type, for example made of a foam material. By means of this, it can be prevented that resin used in connecting the rotor blade spar cap, made from spar cap elements connected to one another, and the rotor blade shell can penetrate into cavities formed between the spar cap elements and the rotor blade shell. In addition to saving material, this also offers the possibility of influencing the elastic properties of the composite of the rotor blade spar cap and the rotor blade shell.

As an alternative, the deformable filling material can also be constructed in the form of a fiber material. When the spar cap elements connected to one another are being connected to the rotor blade shell, the fiber material is preferably impregnated with resin. By means of this, the connection can be made with a fiber-reinforced plastic material instead of pure resin, so that the connection is stronger and more durable.

In a further preferred embodiment, at least one of the at least two strip-shaped spar cap elements is a stiffening element which is arranged, together with the at least one further spar cap element, on the at least one spar cap forming surface of the spar cap mold and is connected so as to form the rotor blade spar cap. For example, core materials and cover layers can also be inserted into the rotor blade spar cap in this way, in order to enable a sandwich-like structure of the rotor blade spar cap with a particularly high bending stiffness to be achieved. In this context, the stiffening element can be arranged in particular in areas of the spar cap elements in which the rotor blade spar cap is formed from only a single one of the spar cap elements, for example in the case of spar cap elements which are arranged next to each other or, if a plurality of spar cap elements of different lengths are arranged one above the other, in the end region of the spar cap elements.

In a further preferred embodiment, the strip-shaped spar cap elements arranged on the at least one spar cap forming surface have a substantially rectangular cross section with a thickness of between 2 mm and 6 mm and/or a width of between 50 mm and 300 mm. Such spar cap elements, which may be manufactured for example by means of a pultrusion process, are particularly economical. At the same time, spar cap elements with such a cross section can already have a bending stiffness which, when a plurality of such spar cap elements are connected in the spar cap mold, cumulates to result in an overall stiffness which, even in the case of biasing caused by the introduction into the rotor blade shell, absorbs the effects of further thermal and/or mechanical loads.

In a further preferred embodiment, the spar cap mold is constructed in such a way that, in the cross section perpendicular to the longitudinal direction, a surface of the spar cap mold which is formed by the spar cap forming surfaces, which are inclined with respect to one another, follows a polygonal chain which replicates or approximates a curvature of a rotor blade shell of the rotor blade in relation to a rotor blade transverse axis which is perpendicular to the rotor blade longitudinal axis. Such a polygonal chain corresponding to the curvature of the rotor blade shell can easily be determined, for example by means of mathematical optimization methods, for example from a model of the rotor blade. In this context, in a preferred manner, the connecting edges of the polygonal chain correspond to portions of the rotor blade shell, with each connecting edge running substantially parallel to, but at least tangentially to, the rotor blade shell in the corresponding portion.

The spar cap mold therefore enables a rotor blade spar cap to be manufactured which is optimally adapted to the curvature of the rotor blade shell, in particular in relation to the predetermined width of its spar cap elements, so that no stresses are generated in the rotor blade spar cap when it is being inserted into the rotor blade shell.

Further advantages, features and possible applications of the present invention will be apparent from the following description in connection with the figures.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 shows a cross section of an example of a spar cap mold for the manufacture of a rotor blade spar cap for a rotor blade of a wind energy installation; and

FIG. 2 shows an example of a rotor blade shell into which a rotor blade spar cap of spar cap elements which are connected to one another is introduced.

### DETAILED DESCRIPTION

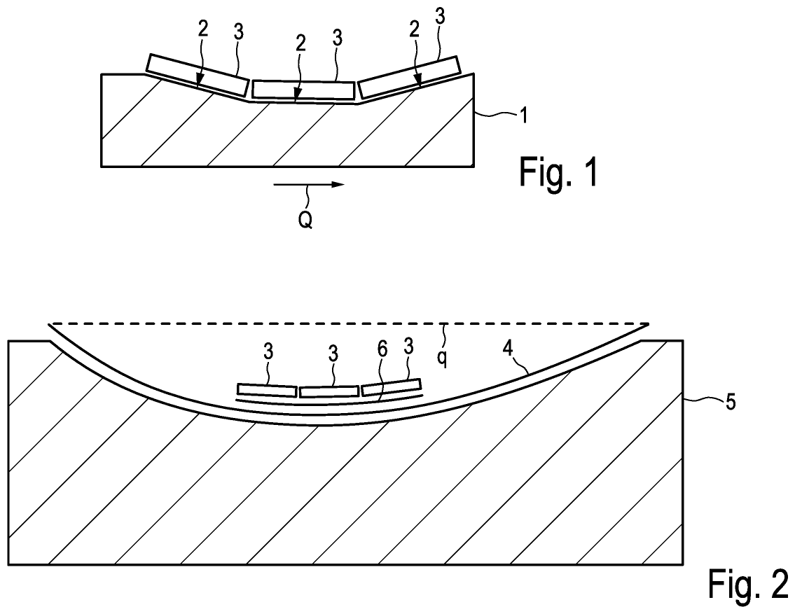

FIG. 1 shows an example of a spar cap mold 1 for the manufacture of a rotor blade spar cap for a rotor blade of a wind energy installation in a cross section along a transverse direction Q of the spar cap mold 1. The spar cap mold 1 comprises three substantially flat spar cap forming surfaces 2 which are located next to each other in the transverse direction Q. In this context, each of the spar cap forming surfaces 2 is arranged to receive, and/or to support, a strip-shaped spar cap element 3 of the rotor blade spar cap. In this context, the spar cap elements 3 placed on the spar cap forming surfaces 2 extend along a longitudinal direction of the spar cap mold 1, which longitudinal direction of the spar cap mold 1 runs perpendicular to the transverse direction Q and thus perpendicular to the drawing plane. This longitudinal direction corresponds to a rotor blade longitudinal axis which runs from a rotor blade root to a rotor blade tip, so that the spar cap elements 3 arranged on the spar cap forming surfaces 2 can be connected to each other, can be removed from the spar cap mold 1 and can be arranged in the rotor blade as a rotor blade spar cap along the rotor blade longitudinal axis.

In this context, the spar cap forming surfaces 2 are formed, for example, by a surface of the spar cap mold 1, which surface of the spar cap mold 1 is segmented in accordance with the spar cap forming surfaces 2. The spar cap forming surfaces 2 are inclined with respect to each other, so that, in the cross section shown, the surface follows a polygonal chain which replicates or approximates a curvature of the rotor blade or of a rotor blade shell of the rotor blade along a rotor blade transverse axis perpendicular to the rotor blade longitudinal axis. Therefore, the spar cap mold 1 causes the spar cap elements 3 to be arranged in an arrangement which corresponds to the curvature of the rotor blade, so that spar cap elements 3 which are connected to each other in the spar cap mold 1 by, for example, a resin infusion process do not need to be deformed and thus do not need to be placed under tension in order to conform to the shape of the rotor blade.

FIG. 2 shows an example of a rotor blade shell 4 of a rotor blade, into which a rotor blade spar cap made up of three spar cap elements 3 which are connected to each other, in particular using the spar cap mold shown in FIG. 1, is introduced. Here, the arrangement of the spar cap elements 3 substantially corresponds to the curvature of the rotor blade shell 4, so that the spar cap elements 3 are substantially free of tension. The tension in the spar cap elements 3 can also be reduced by stacking further spar cap elements 3 or further stiffening materials (not shown) on top of the three spar cap elements 3 and connecting them to each other, since the bending stiffness is increased in this way.

The rotor blade shell 4 is manufactured in a rotor blade mold 5, which has a top surface the shape of which defines the curvature of the rotor blade shell along a rotor blade transverse axis q which extends from a rotor blade leading edge (nose) to a rotor blade trailing edge.

A deformable filling material 6 is arranged between the spar cap elements 3, which are connected to one another, and the rotor blade shell 4, which filling material 6 adapts, in the direction of the transverse axis q of the rotor blade, to the shape of the rotor blade shell 4 and/or the spar cap elements 3, which are connected to one another. In particular, the deformable filling material 6 fills the space between the spar cap elements 3, which are connected to one another, and the rotor blade shell 4, which space arises because the curvature replicated by the spar cap elements 3, which are arranged next to each other and which are inclined with respect to each other, only approximates the actual curvature of the rotor blade shell 4.

The spar cap elements 3, which are connected to one another, are preferably joined to the rotor blade shell 4 with the aid of a resin infusion process. As part of this, the deformable filling material 6 is impregnated with resin and forms a solid fiber-reinforced plastics material in the space between the spar cap elements 3 and the rotor blade shell 4.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

What is claimed is:

1. A method of introducing a rotor blade spar cap into a rotor blade shell (4) for a rotor blade of a wind energy installation, which rotor blade has a rotor blade longitudinal axis which extends from a rotor blade root to a rotor blade tip, wherein
at least two strip-shaped spar cap elements (3) are arranged on at least one substantially flat spar cap forming surface (2) of a spar cap mold (1), wherein the at least one spar cap forming surface (2) extends along a longitudinal direction of the spar cap mold (1) which corresponds to the longitudinal axis of the rotor blade,
the spar cap elements (3) which are arranged on the at least one spar cap forming surface (2) are connected to one another so as to form a rotor blade spar cap, and
the spar cap elements (3) connected to one another are removed from the spar cap mold (1), are introduced into the rotor blade shell (4), and are connected to the rotor blade shell (4).

2-11. (canceled)
